(19) United States
(12) Patent Application Publication
(10) Pub. No.: US 2026/0346206 A1
(43) Pub. Date: Nov. 5, 2026

(54) SEPARATION MEMBRANE MODULE AND MANUFACTURING METHOD THEREOF

(71) Applicant: TORAY ADVANCED MATERIALS KOREA INC., Gumi-si (KR)

(72) Inventors: Sunggeun CHO, Gumi-si (KR); Sungpyo Hong, Gumi-si (KR); Sangheum RYU, Gumi-si (KR); Dohyung PARK, Gumi-si (KR); Jeongwoo LEE, Gumi-si (KR); Soohyeong PARK, Gumi-si (KR)

(73) Assignee: TORAY ADVANCED MATERIALS KOREA INC., Gumi-si (KR)

(21) Appl. No.: 19/487,127

(22) PCT Filed: Mar. 28, 2024
(86) PCT No.: PCT/KR2024/003921

§ 371 Date: Nov. 24, 2025

(30) Foreign Application Priority Data
May 24, 2023 (KR) 10-2023-0067124

(51) Int. Cl. B01D 63/10; B01D 69/12

(52) U.S. Cl. CPC B01D 63/101; B01D 69/12; B01D 2313/14; B01D 2325/40

(57) ABSTRACT

Provided are a separation membrane module and a manufacturing method thereof. A separation membrane module according to an embodiment of the present invention comprises: an outlet pipe; a cylindrical filter assembly; and a wrapping part including a composite fiber which is wound to wrap an outer surface of the filter assembly and includes an inorganic fiber and a polymer resin, wherein the wrapping part is implemented such that at least a part thereof is coupled through the polymer resin between adjacent composite fibers. According to a separation membrane module and a manufacturing method thereof, a defect rate is low; high-pressure durability is an excellent; the risk of a worker accident is prevented by process automation; and a low-temperature process is possible and process time and cost are reduced.

### CROSS-REFERENCE TO RELATED APPLICATION

This application is a national phase application under 35 U.S.C. § 371 of International Application No. PCT/KR2024/003921, filed Mar. 28, 2024, which claims priority to and the benefit of Korean Application No. 10-2023-0067124, filed May 24, 2023. The contents of the referenced patent applications are incorporated into the present application by reference.

### FIELD OF THE DISCLOSURE

The present invention relates to a separation membrane module, and more specifically to a separation membrane module having a low defect rate and excellent high-pressure durability, eliminating the risk of worker accidents due to process automation, enabling low-temperature processing and reducing process time and cost, and a manufacturing method thereof.

### DESCRIPTION OF RELATED ART

Depending on their pore size, separation membranes are classified into microfiltration (MF), ultrafiltration (UF), nanofiltration (NF) and reverse osmosis (RO).

In order to apply such separation membranes to industrial-scale liquid separation, a considerably large membrane area is required. A device unit that integrates a large membrane area into a compact size is called a separation membrane module, and various types of membrane module formats, such as plate-type modules, tubular modules, hollow fiber modules and spiral wound modules, have been developed, and particularly, the osmosis membrane modules that have been commercialized recently mainly use spiral-wound-type modules.

The spiral-wound-type module performs a wrapping process by winding a predetermined fiber on the outer surface, and in the past, the wrapping process was performed by spraying a mixture of an epoxy resin and a curing agent while winding the fiber. However, the epoxy resin and the curing agent scattered, and the curing failure frequently occurred, which increase the defect rate. In addition, since the curing time was very long, the process time became excessively long. Moreover, since the mixture solution of an epoxy resin and a curing agent was used, there was a problem that it was not very environmentally friendly when it was disposed of after usage. Additionally, since the wet wrapping process was performed, a squeezing operation was absolutely necessary to treat the surface of the resin flowing down from the surface during the work, and since the squeezing operation inevitably required a worker, there was a problem that it was difficult to automate the process and that the risk of accidents to the worker could not be ruled out. Moreover, since a low-temperature process was not possible, there were problems that the process time was long, and the process cost was also high.

### SUMMARY

The present invention has been devised in consideration of the above-described points, and an object of the present invention is to provide a separation membrane module, which has a low defect rate and excellent high-pressure durability, eliminates the risk of worker accidents due to process automation, enables low-temperature processing and reduces process time and cost, and a manufacturing method thereof.

In order to solve the above-described problems, the present invention provides a separation membrane module, including: an outlet pipe; a cylindrical filter assembly disposed to surround an outside of the outlet pipe; and a wrapping part in which a composite fiber including an inorganic fiber and a polymer resin is wound to wrap an outer surface of the filter assembly, wherein at least a part of the wrapping part is coupled through the polymer resin between adjacent composite fibers.

According to an embodiment of the present invention, the composite fiber may be a sheath-core-type composite fiber including a core part and a sheath part, and the composite fiber may include an inorganic fiber in the core part, and include a polymer resin in the sheath part.

In addition, the inorganic fiber may include any one or more of glass fibers, carbon fibers and metal fibers.

In addition, the polymer resin may include a UV-curable resin.

In addition, the polymer resin may include one or more selected from the group consisting of epoxy-based acrylate, urethane-based acrylate, polyester-based acrylate, polyether-based acrylate and polyacrylic-based acrylate.

In addition, the composite fiber may include 10 to 70 parts by weight of the polymer resin based on 100 parts by weight of the inorganic fiber.

In addition, the filter assembly may be wound in a spiral shape on the outlet pipe.

In addition, the filter assembly may include: a separation membrane provided to be bent so as to form at least one leaf; an internal spacer disposed inside the leaf; and an external spacer disposed outside the leaf.

In addition, the inner spacer may include a mesh sheet, and the outer spacer may include a tricot permeate water channel.

In addition, the present invention provides a method for manufacturing a separation membrane module, the method including: winding a precursor composite fiber manufactured by impregnating an inorganic fiber with a polymer resin composition including a polymer resin, on an outlet pipe and a cylindrical filter assembly disposed to surround an outside of the outlet pipe; and forming a wrapping part by curing the polymer resin of the precursor composite fiber such that adjacent composite fibers are at least partially coupled through the polymer resin.

According to an embodiment of the present invention, the composite fiber may include 10 to 70 parts by weight of the polymer resin based on 100 parts by weight of the inorganic fiber.

In addition, the polymer resin may include a UV-curable resin, and in the forming a wrapping part, the curing may be performed under a condition of a UV irradiation dose of 1,300 to 1,500 mJ/cm².

According to the present invention, the separation membrane module and manufacturing method thereof can exhibit the effects of having a low defect rate and excellent high-pressure durability, excluding the risk of worker accidents due to process automation, enabling low-temperature processing and reducing process time and cost at the same time.

### BRIEF DESCRIPTION OF DRAWINGS

FIG. 1 is a perspective view of a separation membrane module according to an embodiment of the present invention, and

FIG. 2 is a cross-sectional mimetic diagram of an outlet pipe and a filter assembly provided in the separation membrane module according to an embodiment of the present invention.

### DETAILED DESCRIPTION OF THE INVENTION

Hereinafter, with reference to the attached drawings, embodiments of the present invention will be described in detail so that those skilled in the art can easily practice the present invention. The present invention may be implemented in various different forms and is not limited to the embodiments described herein. In the drawings, parts that are not related to the description are omitted in order to clearly describe the present invention, and the same reference numerals are assigned to the same or similar components throughout the specification.

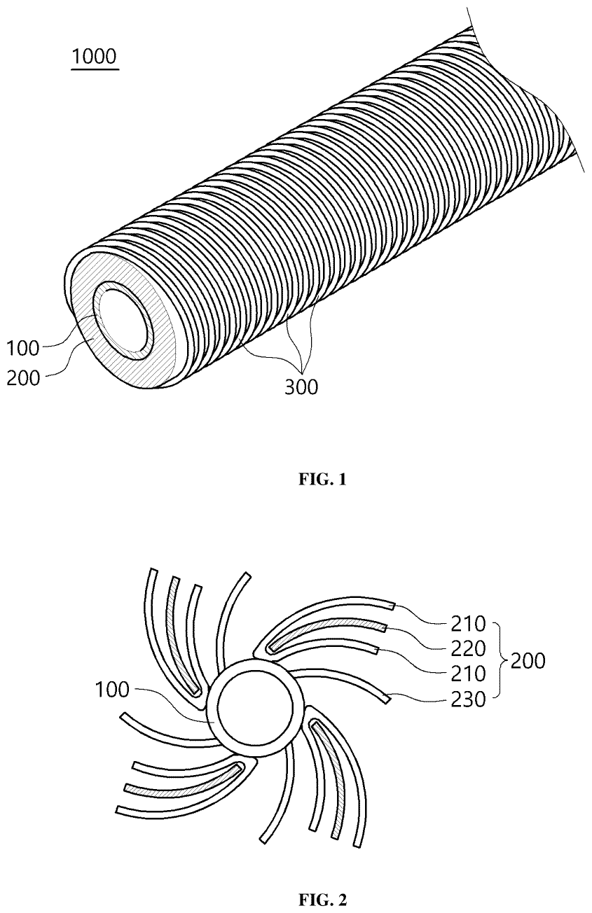

As illustrated in FIG. 1, the separation membrane module 1000 according to the present invention includes an outlet pipe 100; a cylindrical filter assembly 200 disposed to surround an outside of the outlet pipe; and a wrapping part 300 in which a composite fiber including an inorganic fiber and a polymer resin are wound to wrap an outer surface of the filter assembly 200, wherein the wrapping part 300 is implemented such that at least a part thereof is coupled through the polymer resin between adjacent composite fibers.

Hereinafter, each component included in the separation membrane module 1000 of the present invention will be described.

First of all, the outlet pipe 100 will be described.

The outlet pipe 100 may be formed of a hollow pipe member having any one or both ends open and including at least one hole through which produced water flows in.

Since the outlet pipe may be used without limitation as long as it is a known outlet pipe that can be applied to a separation membrane module, the present invention does not specifically limit the same.

Next, the filter assembly 200 will be described.

The filter assembly 200 may be a filter assembly having a cylindrical structure disposed to surround an outside of the outlet pipe, and may preferably be wound in a spiral shape on the outlet pipe 100 as shown in FIG. 2.

When the filter assembly is wound in a spiral shape, the filter assembly 200 may include a separation membrane 210 that is provided by being bent to form at least one leaf, an internal spacer 220 disposed inside the leaf, and an external spacer 230 disposed outside the leaf.

Looking at the raw water treatment process by the separation membrane module 1000, the influent water passes through the inner spacer 220 and the separation membrane 210. In the process of passing through the separation membrane 210, dissolved salts and organic matter are excluded, and pure water is separated. The separated water flows along the outer spacer 230, and this separated water is collected in the outlet pipe 100 located at a center and discharged to the outside of the separation membrane module 1000.

Since the separation membrane 210 may be used without limitation as long as it is a separation membrane that can be commonly applied to a separation membrane module in the art, the present invention does not specifically limit the same.

In addition, the internal spacer 220 serves to form a flow path inside the leaf, and specifically, as the internal spacer 220 is disposed inside the leaf in which the separation membrane 210 is formed by being bent, it may greatly improve the formation of a flow path inside the leaf as a feed channel.

The internal spacer 220 may be used without limitation as long as it is an internal spacer that can be commonly applied to a separation membrane module in the art, and preferably, it may include a mesh sheet.

The mesh sheet may be used without limitation in the case of a mesh sheet that can be used as an internal spacer of a filter assembly, and preferably, polypropylene, polyethylene or a polyolefin-based copolymer in which polypropylene and polyethylene are mixed in a certain ratio may be used as the material of the mesh sheet.

The internal spacer 220 may have an average pore of 6 mm² to 20 mm², and preferably 9 mm² to 17 mm², to facilitate the formation of a flow path. If the pore is less than 6 mm², there may be a problem of hindering the formation of a flow path, and if it is more than 20 mm², there may be a problem of reducing membrane deformation and fouling during high-pressure operation.

In addition, the average thickness of the internal spacer 220 may be 0.2 mm to 3 mm, and preferably 0.2 mm to 2.0 mm. If the average thickness of the internal spacer 220 is less than 0.2 mm, sufficient flow path may not be secured, and if it is more than 3 mm, the effective membrane area per unit volume may be reduced, which may affect the deterioration of module performance.

The external spacer 230 is disposed outside the leaf and serves to form a flow path outside the leaf, and specifically, the external spacer 230 is disposed outside the leaf, and when there are two or more leaves, it is disposed between the leaves, thereby being able to function as a permeate spacer.

The external spacer 230 may be used without limitation as long as it is an external spacer that can be commonly applied to a separation membrane module in the art, and preferably, it may include a tricot permeate water channel.

The tricot permeate water channel may be used without limitation as long as it is a tricot that can be used as an external spacer of a filter assembly, and preferably, any one or more resins selected from the group consisting of polypropylene, polyethylene, poly-4-methylpentene, propylene-α olefin crystalline copolymer, polyethylene terephthalate, polybutylene terephthalate, polyamide and polycarbonate, or a polyethylene terephthalate resin copolymerized with nylon, polypropylene or an epoxy resin, may be formed into a modified polyester (low melting polyethylene terephthalate, LMP).

Next, the wrapping part 300 will be described.

As described above, the wrapping part 300 is formed by winding a composite fiber including an inorganic fiber and a polymer resin to wrap an outer surface of the filter assembly 200, and the wrapping part 300 is implemented such that at least a part thereof is coupled through the polymer resin between adjacent composite fibers.

The composite fiber may be any one or more of a sheath-core-type composite fiber including a core part and a sheath part and a side-by-side type composite fiber, but it is more preferable to be a sheath-core-type composite fiber including a core part and a sheath part in that at least a part thereof is coupled through the polymer resin between adjacent composite fibers.

In addition, the sheath-core-type composite fiber may be a concentric sheath-core-type composite fiber in which the centers of the core part and sheath part are the same, or may be an eccentric sheath-core-type composite fiber in which the centers of the core and sheath parts are different, but the present invention does not specifically limit the same.

In this case, the sheath-core-type composite fiber may include an inorganic fiber in the core part and may include a polymer resin in the sheath part.

Meanwhile, the inorganic fiber may be used without limitation as long as it is an inorganic fiber that can be commonly used in the art, and preferably may include any one or more of glass fibers, carbon fibers and metal fibers, and more preferably, including glass fiber may be more advantageous in achieving the object of the present invention.

In addition, the inorganic fiber may be a monofilament or a multifilament formed of a fiber bundle, and when the inorganic fiber is a multifilament, the multifilament may include any one of the glass fibers, carbon fibers and metal fibers alone, or may include any two or more of the glass fibers, carbon fibers and metal fibers in combination.

In addition, the polymer resin may be used without limitation as long as it is a polymer resin that can be commonly used in the art, and it may be more advantageous to achieve the object of the present invention to include a UV-curable resin. The UV-curable resin may preferably include one or more selected from the group consisting of an epoxy-based acrylate, a urethane-based acrylate, a polyester-based acrylate, a polyether-based acrylate and a polyacrylic-based acrylate, and accordingly, it may be more advantageous to achieve the object of the present invention.

In this case, the UV-curable resin may further include a UV initiator, and since the UV initiator may be used without limitation as long as it is a known UV initiator, the present invention does not specifically limit the same. The UV initiator may be included in an amount of 0.5 to 7 parts by weight, and preferably 1 to 6 parts by weight, based on 100 parts by weight of the UV-curable resin. When the UV initiator satisfies the above content, it may be more advantageous in achieving the object of the present invention.

In addition, the composite fiber may be formed by twisting fibers including the polymer resin onto the inorganic fiber, or may be formed by impregnating or coating with a polymer resin composition such that the polymer resin is disposed on a surface of the inorganic fiber. Preferably, it may be more advantageous in achieving the object of the present invention to form the composite fiber by impregnating with a polymer resin composition such that the polymer resin is disposed on a surface of the inorganic fiber.

In addition, the composite fiber may include the polymer resin in an amount of 10 to 70 parts by weight, and preferably 15 to 65 parts by weight, based on 100 parts by weight of the inorganic fiber. If the amount of the polymer resin is less than 10 parts by weight based on 100 parts by weight of the inorganic fiber, the composite fiber may not be fixed to an outer surface of the filter assembly, and the durability of the separation membrane module may be deteriorated, such as causing defects. In addition, if the amount of the polymer resin is more than 70 parts by weight based on 100 parts by weight of the inorganic fiber, the durability of the separation membrane module may be deteriorated, such as causing defects under high-pressure conditions.

The separation membrane module according to the present invention is manufactured by a manufacturing method including the steps of winding a precursor composite fiber manufactured by impregnating an inorganic fiber with a polymer resin composition including a polymer resin, on an outlet pipe and a cylindrical filter assembly disposed to surround an outside of the outlet pipe, and forming a wrapping part by curing the polymer resin of the precursor composite fiber such that adjacent composite fibers are at least partially coupled through the polymer resin.

In the description of the manufacturing method of the separation membrane module, the same description for each component described in the above-described membrane module will be omitted and described.

Since the polymer resin may include a UV-curable resin as described above, the curing of a polymer resin in the step of forming a wrapping part may be performed through UV irradiation.

In this case, the curing may be performed under a condition of a UV irradiation dose of 1,300 to 1,500 mJ/cm², and preferably under a condition of 1,330 to 1,470 mJ/cm². If the UV irradiation dose is less than 1,300 mJ/cm², the UV-curable resin may not be cured to the desired level, and if the UV irradiation dose is more than 1,500 mJ/cm², the process time may become longer, discoloration due to over-curing may occur, and physical properties may deteriorate.

According to the present invention, the separation membrane module and the manufacturing method thereof can exhibit the effects of having a low defect rate and excellent high-pressure durability, excluding the risk of worker accidents due to process automation, enabling low-temperature processing, and reducing process time and cost at the same time.

### EXAMPLES

The present invention will be described more specifically through the following examples, but the following examples do not limit the scope of the present invention, and should be interpreted as helping to understand the present invention.

### EXAMPLE

### Example 1

First of all, a separation membrane in which a membrane (polyamide membrane) was sequentially laminated in a stepwise structure with a step spacing of 5 mm on an outlet pipe with a diameter of 8 inches was bent, and 24 leaves were formed such that a mesh sheet of a polyethylene and polypropylene composite material, which is an internal spacer, was disposed inside the separation membrane, and a filter assembly that was formed such that a tricot, which is an external spacer, was disposed in an area between the formed leaves was rolled into a structure as shown in FIG. 2 to manufacture a spiral-wound-type module.

In addition, a precursor composite fiber was manufactured by impregnating a glass fiber (OWENS CORNING KOREA, SE4540-2200TEX), which is an inorganic fiber, with a polymer resin composition in which 3 parts by weight of a radical initiator (IGM RESINS, Omnirad 1173) based on 100 parts by weight of an epoxy acrylate resin (Kukdo Chemical, DP-75), which is a UV-curable resin, was mixed at 50 °C for 2 hours by using a blade that is capable of adjusting a gap at a temperature of 50 °C.

Afterwards, the precursor composite fiber was wound under the conditions of a conveying speed of 1,400 mm/min (in the longitudinal direction of the outlet pipe) of the spiral-wound-type module and a rotation speed of 120 times/min of the spiral-wound-type module so as to wrap an outer surface of the filter assembly in the longitudinal direction of the outlet pipe, and UV was irradiated at a UV lamp distance of 35 mm for 27 seconds to cure the UV-curable resin under the conditions of a UV irradiation dose of 1,463 mJ/cm², thereby manufacturing a separation membrane module including a wrapping part in which a composite fiber including an inorganic fiber and a polymer resin was wound to wrap an outer surface of the filter assembly. In this case, the polymer resin was 53.8 parts by weight based on 100 parts by weight of the inorganic fiber, and the composite fiber was formed as a sheath-core-type composite fiber including an inorganic fiber in a core part and a polymer resin in a sheath part.

### Examples 2 to 8 and Comparative Example 1

Separation membrane module were manufactured in the same manner as in Example 1, except that the content of the polymer resin, the dose of UV irradiation, the inclusion of a wrapping part and the like were changed as shown in Tables 1 and 2.

### Comparative Example 2

A separation membrane module was manufactured in the same manner as in Example 1, except that instead of the composite fiber, a glass fiber that was in contact with a mixture solution of an epoxy resin and a curing agent was wound in the longitudinal direction of the outlet pipe of the spiral-wound-type module to wrap the outer surface of the filter assembly, and curing was performed in a curing room at a temperature of 38 °C for 10 hours to manufacture a separation membrane module.

### Comparative Example 3

A separation membrane module was manufactured in the same manner as in Example 1, except that it was cured for 27 seconds in a curing room at 60 °C.

### Experimental Example

The following items were evaluated for the separation membrane modules manufactured in the examples and comparative examples, and the results are shown in Tables 1 and 2 below.

### 1. Evaluation of Defect Rate

The defect rate was evaluated for the separation membrane modules according to the examples and comparative examples. Specifically, the defect rates of the separation membrane modules manufactured according to the examples and comparative examples were evaluated visually and tactilely by 15 people with more than 10 years of experience in the relevant field. In this case, the average was calculated out of 10 points, and the defect rate was evaluated as ∘ for 8 points or more, Δ for 4 points or more to less than 8 points, and × for less than 4 points.

### 2. Evaluation of High-Pressure Durability

When operated under 600 psi conditions, high-pressure durability was evaluated as—∘ if there were no problems, and—× if any problems occurred, such as channeling phenomenon in which internal components protrude.

TABLE 1

| | Example | Example | Example | Example | Example | Example |
|---|---|---|---|---|---|---|
| Classification | 1 | 2 | 3 | 4 | 5 | 6 |
| Content of polymer resin | 53.8 | 5 | 15 | 65 | 75 | 53.8 |
| (parts by weight) | | | | | | |
| UV irradiation dose (mJ/cm²) | 1463 | 1463 | 1463 | 1463 | 1463 | 1241 |
| Inclusion of wrapping part | Included | Included | Included | Included | Included | Included |
| Curing temperature (°C) | 50 | 50 | 50 | 50 | 50 | 50 |
| Curing time (sec) | 27 | 27 | 27 | 27 | 27 | 26.1 |
| Evaluation of defect rate | ∘ | Δ | ∘ | ∘ | ∘ | Δ |
| Evaluation of high-pressure | ∘ | x | ∘ | ∘ | x | x |
| durability | | | | | | |

TABLE 2

| | | | Comparative | Comparative | Comparative |
|---|---|---|---|---|---|
| | Example | Example | Example | Example | Example |
| Classification | 7 | 8 | 1 | 2 | 3 |
| Content of polymer resin | 53.8 | 53.8 | — | — | — |
| (parts by weight) | | | | | |
| UV irradiation dose (mJ/cm²) | 1336 | 1595 | — | — | — |
| Inclusion of wrapping part | Included | Included | Not included | Included | Included |
| Curing temperature (°C) | 50 | 50 | — | 60 | 60 |
| Curing time (sec) | 26.5 | 28.3 | — | 3600 | 27 |
| Evaluation of defect rate | ∘ | Δ | x | ∘ | x |
| Evaluation of high-pressure | ∘ | x | x | ∘ | x |
| durability | | | | | |

As can be seen from Tables 1 and 2 above, Examples 1, 3, 4 and 7, which satisfied all of the content of polymer resin, UV irradiation dose, the inclusion of a wrapping part, the type of polymer resin, curing method and time according to the present invention, had significantly lower defect rates, significantly superior high-pressure durability and a significantly shorter process time, compared to Examples 2, 5, 6 and 8 and Comparative Examples 1 to 3, which did not satisfy any one of the above.

Although an embodiment of the present invention has been described above, the spirit of the present invention is not limited to the embodiment presented in the present specification, and those skilled in the art who understand the idea of the present invention will be able to easily propose other embodiments by modifying, changing, deleting or adding components within the scope of the same spirit, but this will also be considered to fall within the spirit of the present invention.

### EXPLANATION OF REFERENCE NUMERALS

100: Outlet pipe
200: Filter assembly
210: Separation membrane
220: Internal spacer
230: External spacer
300: Wrapping part
1000: Separation membrane module

1. A separation membrane module, comprising:
an outlet pipe;
a cylindrical filter assembly disposed to surround an outside of the outlet pipe; and
a wrapping part in which a composite fiber comprising an inorganic fiber and a polymer resin is wound to wrap an outer surface of the filter assembly,
wherein at least a part of the wrapping part is coupled through the polymer resin between adjacent composite fibers.

2. The separation membrane module of claim 1, wherein the composite fiber is a sheath-core-type composite fiber comprising a core part and a sheath part, and wherein the composite fiber comprises an inorganic fiber in the core part, and comprises a polymer resin in the sheath part.

3. The separation membrane module of claim 1, wherein the inorganic fiber comprises any one or more of glass fibers, carbon fibers and metal fibers.

4. The separation membrane module of claim 1, wherein the polymer resin comprises a UV-curable resin.

5. The separation membrane module of claim 1, wherein the polymer resin comprises one or more selected from the group consisting of epoxy-based acrylate, urethane-based acrylate, polyester-based acrylate, polyether-based acrylate and polyacrylic-based acrylate.

6. The separation membrane module of claim 1, wherein the composite fiber comprises 10 to 70 parts by weight of the polymer resin based on 100 parts by weight of the inorganic fiber.

7. The separation membrane module of claim 1, wherein the filter assembly is wound in a spiral shape on the outlet pipe.

8. The separation membrane module of claim 7, wherein the filter assembly comprises:
a separation membrane provided to be bent so as to form at least one leaf;
an internal spacer disposed inside the leaf; and
an external spacer disposed outside the leaf.

9. The separation membrane module of claim 8, wherein the inner spacer comprises a mesh sheet, and wherein the outer spacer comprises a tricot permeate water channel.

10-12. (canceled)
